(19) United States
(12) Patent Application Publication
(10) Pub. No.: US 2012/0137039 A1
(43) Pub. Date: May 31, 2012

(54) INFORMATION PROCESSING APPARATUS

(75) Inventor: Hiroyuki MURATA, Shiga (JP)

(73) Assignee: Panasonic Corporation, Osaka (JP)

(21) Appl. No.: 13/367,960

(22) Filed: Feb. 7, 2012

Related U.S. Application Data
(63) Continuation of application No. PCT/JP2010/000635, filed on Feb. 3, 2010.

(30) Foreign Application Priority Data
Aug. 17, 2009 (JP) 2009-188221

(51) Int. Cl. G06F 13/36

(52) U.S. Cl. 710/306

(57) ABSTRACT

An information processing apparatus includes information holding circuits provided respectively for a plurality of transfer source bus control devices, an exclusive bus configured to be capable of mutually connecting the plurality of information holding circuits, and bus selection circuits provided respectively for the plurality of transfer source bus control devices and configured to select one of the exclusive bus and the hierarchical bus as a connection destination of each of the transfer source bus control devices.

### CROSS-REFERENCE TO RELATED APPLICATION

This is a continuation of PCT International Application PCT/JP2010/000635 filed on Feb. 3, 2010, which claims priority to Japanese Patent Application No. 2009-188221 filed on Aug. 17, 2009. The disclosures of these applications including the specifications, the drawings, and the claims are hereby incorporated by reference in its entirety.

### BACKGROUND

The present disclosure relates to an information processing apparatus, and more particularly, relates to a technique of reducing bus traffic for an on-chip bus.

A conventional on-chip bus is configured so that a time sharing control mechanism is mounted on the on-chip bus and a buffer is provided in the on-chip bus, thereby reducing bus traffic for the entire on-chip bus (see, for example, Japanese Patent Publication No. 2006-343916).

### SUMMARY

Data in a conventional on-chip architecture is stored in an on-chip memory or a synchronous dynamic random access memory (SDRAM) according to its access frequency and data attribute. However, transfer efficiency in the entire on-chip bus when consecutive processing is shard between transfer source bus control devices is not considered, and therefore, when data is shared to perform consecutive processing between the transfer source bus control devices, an access to a memory is frequently made. As a result, the performance of the on-chip bus might be reduced.

An example information processing apparatus according to the present disclosure may allow reduction in the number of accesses to a memory in an on-chip bus.

As an example, an information processing apparatus which is configured so that a plurality of transfer source bus control devices and a plurality of transfer destination bus control devices transmit/receive data therebetween via a hierarchical bus includes information holding circuits provided respectively for the plurality of transfer source bus control devices, an exclusive bus configured to be capable of mutually connecting the plurality of information holding circuits, and bus selection circuits provided respectively for the plurality of transfer source bus control devices and configured to select one of the exclusive bus and the hierarchical bus as a connection destination of each of the transfer source bus control devices.

Thus, data is obtained via a hierarchical bus, and obtained data is sequentially transferred to a transfer source bus control device via an exclusive bus, thus eliminating need for the transfer source bus control device to access a transfer destination bus control device. Therefore, the number of accesses to transfer destination bus control devices can be reduced in the entire information apparatus.

### BRIEF DESCRIPTION OF THE DRAWINGS

FIG. 1 is a block diagram schematically illustrating a configuration of an information processing apparatus according to a first embodiment.

FIG. 2 is a diagram illustrating a control information format issued by a transfer source bus control device according to the first embodiment.

FIG. 3 is a block diagram schematically illustrating a configuration of an information processing apparatus according to a second embodiment.

FIG. 4 is a block diagram schematically illustrating a configuration of an information processing apparatus according to a third embodiment.

FIG. 5 is a diagram illustrating an address management directory information format according to the third embodiment.

FIG. 6 is a block diagram schematically illustrating a configuration of an information processing apparatus according to a fourth embodiment.

FIG. 7 is a diagram illustrating an external access address monitoring information format according to the fourth embodiment.

FIG. 8 is a block diagram schematically illustrating a configuration of an information processing apparatus according to a fifth embodiment.

FIG. 9 is a block diagram schematically illustrating a configuration of an information processing system according to a sixth embodiment.

FIG. 10 is a diagram illustrating a control information format issued by a transfer source cluster control apparatus according to the sixth embodiment.

FIG. 11 is a block diagram illustrating a cluster configuration according to the sixth embodiment.

### DETAILED DESCRIPTION

Embodiments will be described below with reference to the accompanying drawings.

### First Embodiment

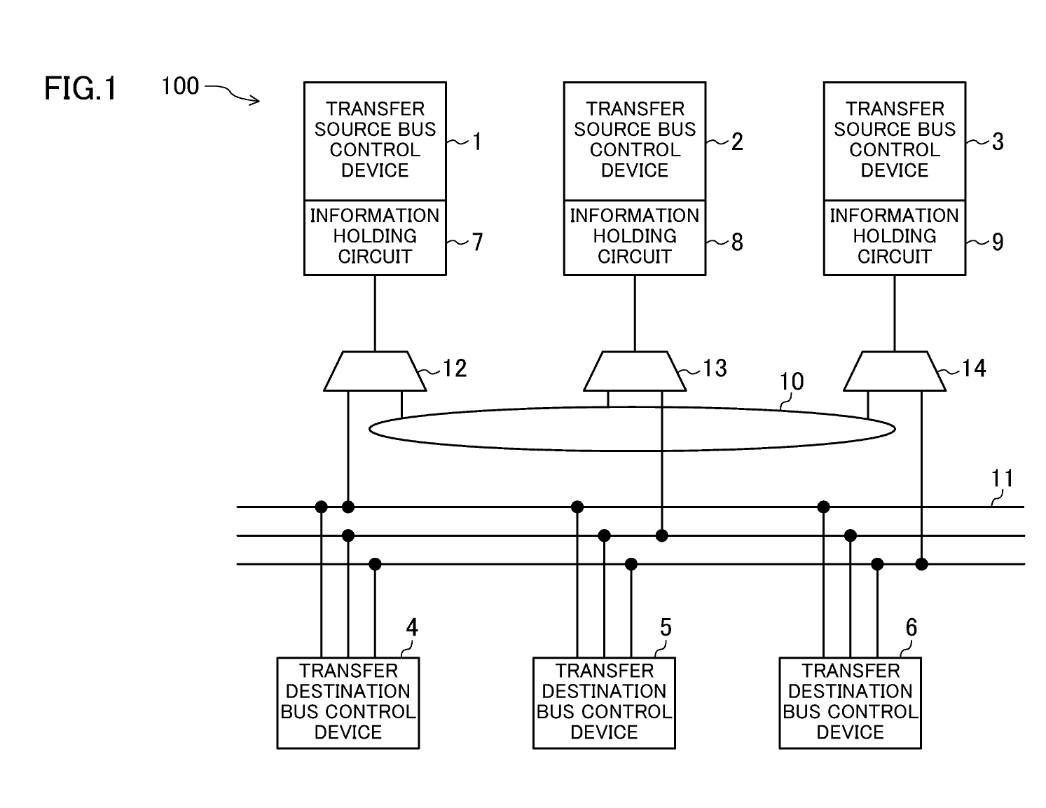

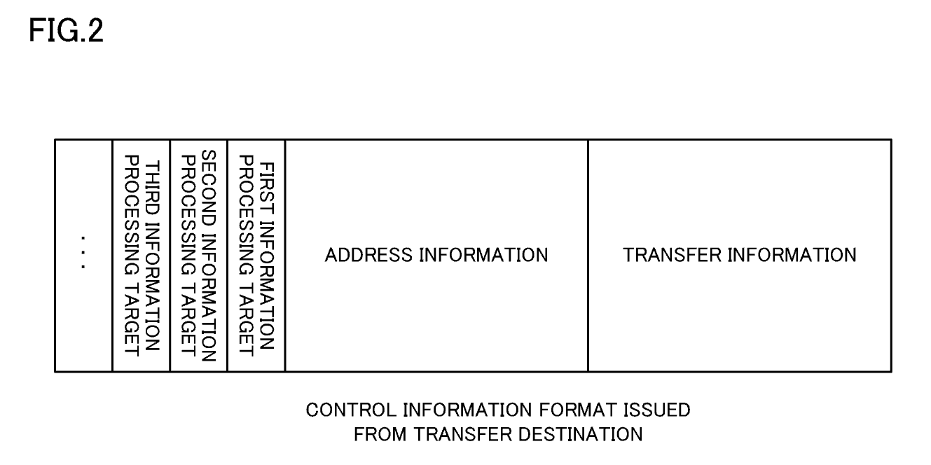

FIG. 1 is a block diagram schematically illustrating a configuration of an information processing apparatus 100 according to a first embodiment. FIG. 2 is a diagram illustrating a control information format issued from transfer source bus control devices 1-3.

The information processing apparatus 100 is configured so that data is transmitted/received between a plurality of transfer source bus control devices 1-3 and a plurality of destination bus control devices 4-6. The information processing apparatus 100 includes information holding circuits 7-9 provided respectively for the plurality of transfer source bus control devices 1-3, a ring bus 10 configured to be capable of mutually connecting the information holding circuits 7-9, a hierarchical bus 11 configured to be capable of connecting the plurality of transfer source bus control devices 1-3 to the plurality of destination bus control devices 4-6, and bus selection circuits 12-14 configured to select one of the ring bus 10 and the hierarchical bus 11 according to output signals of the transfer source bus control devices 1-3.

The operation of the information processing apparatus 100 configured as described above will be described. First, assume a case where information processing is consecutively performed from the transfer source bus control device 1 to the transfer source bus control device 2, and to the transfer source bus control device 3. The transfer source bus control device 1 sets the transfer destination bus control device 4 as address information of control information to output the control information. Thus, the bus selection circuit 12 selects connection to the hierarchical bus 11. The transfer source bus control device 1 obtains data from the transfer destination bus control device 4 to perform information processing.

When information processing is completed, an address of the transfer destination bus control device 5 is set as the address information of the control information, an address of the transfer source bus control device 2 is set as a first information processing target, an address of the transfer source bus control device 3 is set as a second information processing target, and a processing completion data is set as transfer information, and data transfer to the transfer destination bus control device 5 is started. When the address information is set for the control information, the bus selection circuit 12 selects connection to the hierarchical bus to start data transfer from the transfer source bus control device 1 to the transfer destination control device 5. In this case, since addresses are set for the first information processing target and the second information processing target, the bus selection circuit 12 preferentially selects connection to the ring bus 10, and the transfer source bus control device 1 performs data transfer to the information holding circuit 8 of the transfer source bus control device 2 which is the first information processing target.

The bus selection circuits 13 and 14 preferentially select the ring bus 10, when data to be consecutively processed by the transfer source bus control devices 1-3 exist on the ring bus 10. The bus selection circuit 13 receives data from the ring bus 10 to store the data in the information holding circuit 8, when no request for outputting data is made by the transfer source bus control device 2.

The transfer source bus control device 2 can obtain data without accessing to the transfer destination control device 5, since necessary data for processing exists in the information holding circuit 8. When information processing is completed, the transfer source bus control device 2 sets an address of the transfer destination bus control device 6 as the address information of the control information, information processing completion data as transfer information, raises the second information processing target of the control information to the first information processing target, and starts data transfer to the transfer destination bus control device 6. However, since the address of the transfer source bus control device 3 has been set as the first information processing target, the transfer source bus control device 2 performs data transfer to the information holding circuit 9 of the transfer source bus control device 3 which is the first information processing target.

The bus selection circuit 14 receives data from the ring bus 10 to store the data in the information holding circuit 9, when no request for outputting data is made by the transfer source bus control device 3. The transfer source bus control device 3 can obtain data without accessing to the transfer destination bus control device 6, since necessary data for processing exists in the information holding circuit 9.

As described above, information processing can be performed with a fewer accesses to the destination bus control apparatuses 4-6, thus resulting in improvement of the transfer efficiency of the on-chip bus and system-on-a-chip (SoC) performance, and reduction in power consumption of the on-chip bus.

### Second Embodiment

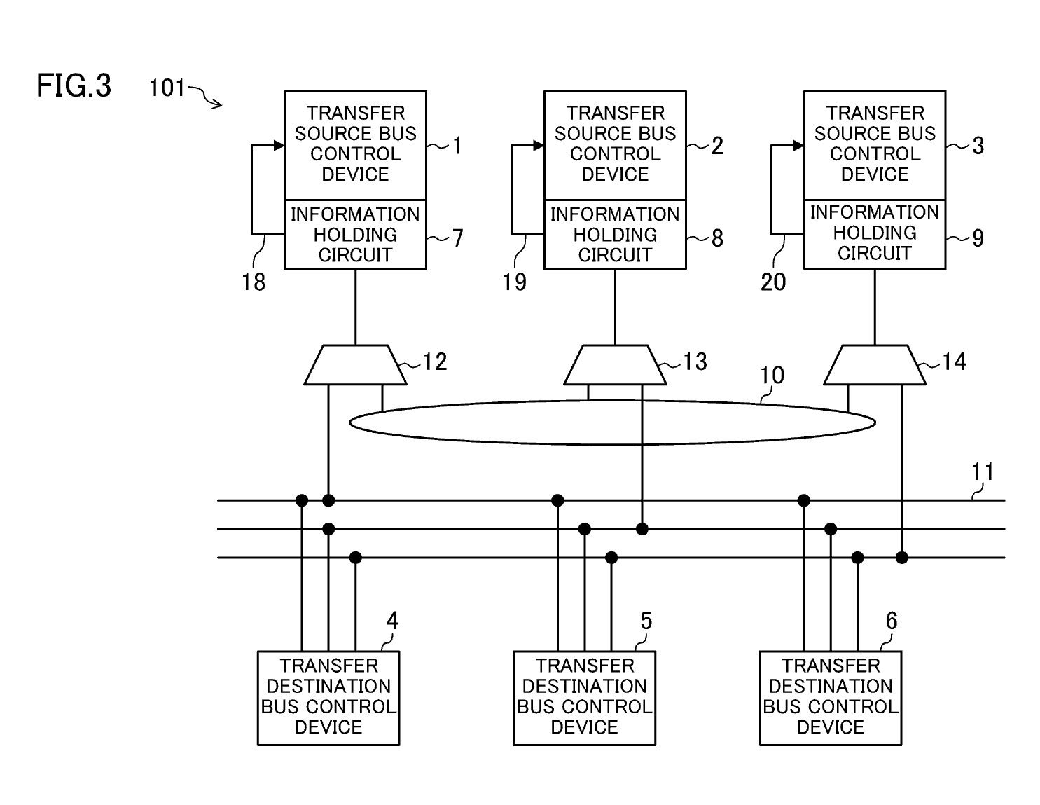

FIG. 3 is a block diagram schematically illustrating a configuration of an information processing apparatus 101 according to a second embodiment. The information processing apparatus 101 employs the control information format of FIG. 2, as in the first embodiment. Only differences of the second embodiment from the first embodiment will be described below.

The information processing apparatus 101 includes notification buses 18-20 each of which is configured to notify an associated one of the transfer source bus control devices 1-3 that data exists in an associated one of the information holding circuits 7-9.

The operation of the information processing apparatus 101 configured as described above will be described below. When information processing is completed in the transfer source bus control device 1, data transfer to the information holding circuit 8 of the transfer source bus control device 2 which is the first information processing target is performed. Upon completing data transfer to the information holding circuit 8, the transfer source bus control device 2 is notified that data exists in the information holding circuit 8 via the notification bus 19. The transfer source bus control device 2 can obtain data without accessing to the transfer destination control device 5, since necessary data for processing exists in the information holding circuit 8.

When information processing is completed, the transfer source bus control device 2 raises the second information processing target of the control information to the first information processing target, and performs data transfer to the information holding circuit 9 of the transfer source bus control device 3. Upon completing data transfer to the information holding circuit 9, the transfer source bus control device 3 is notified that data exists in the information holding circuit 9 via the notification bus 20. The transfer source bus control device 3 can obtain data without accessing to the transfer destination bus control device 6, since necessary data for processing exists in the information holding circuit 9.

As described above, information processing can be performed without need any access to the destination bus control apparatuses 4-6, thus resulting in improvement of the transfer efficiency of the on-chip bus and the SoC performance, and reduction in power consumption of the on-chip bus.

### Third Embodiment

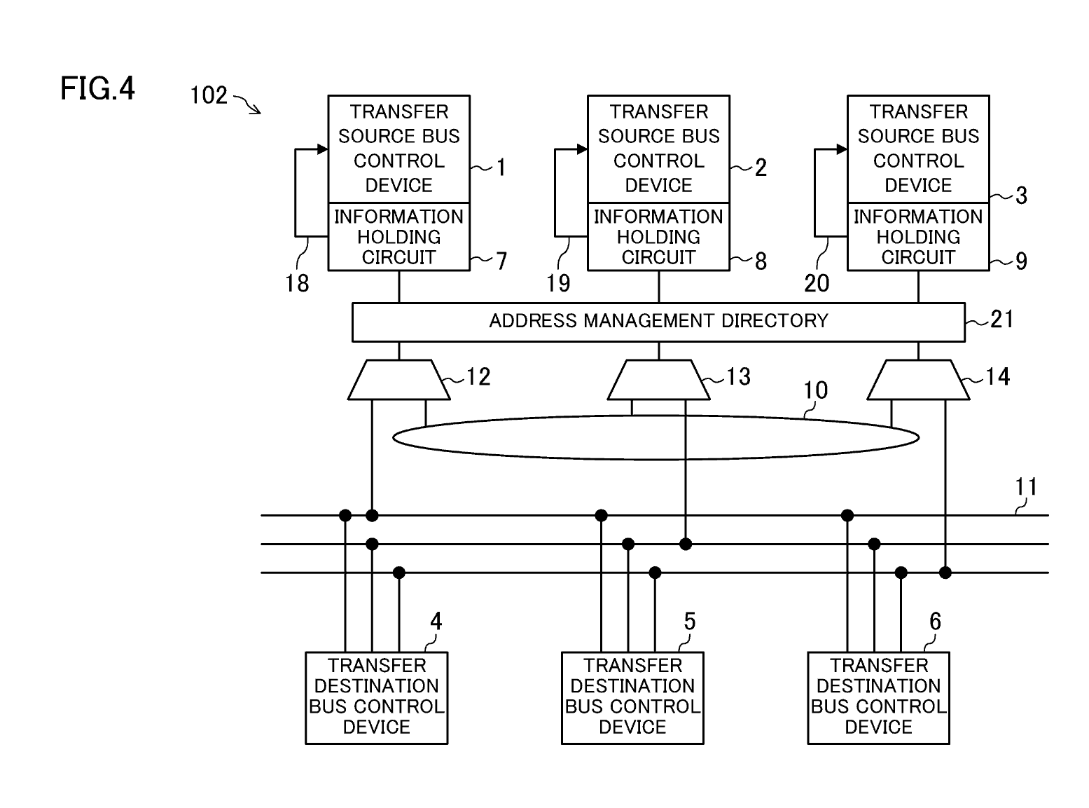

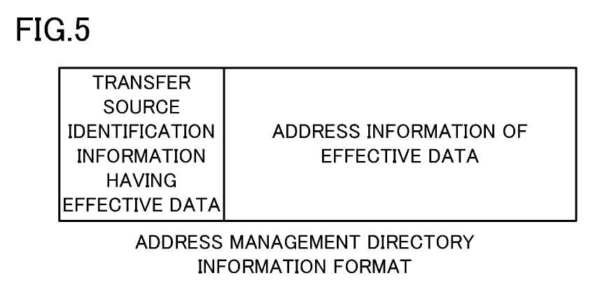

FIG. 4 is a block diagram schematically illustrating a configuration of an information processing apparatus 102 according to a third embodiment. The information processing apparatus 102 employs control information formats of FIG. 2 and FIG. 5. Only differences of the third embodiment from the second embodiment will be described below.

The information processing apparatus 102 includes an address management directory 21 configured to monitor data which passes between the transfer source bus control devices 1-3 and the bus selection circuits 12-14.

The operation of the information processing apparatus 102 configured as described above will be described below. First, assume a case where the transfer source bus control device 3 obtains data from the transfer destination bus control device 4, and furthermore, the transfer source bus control device 1 obtains data from the transfer destination bus control device 4. The transfer source bus control device 3 obtains data from the transfer destination bus control device 4 via the hierarchical bus 11 to hold the data in the information holding circuit 9.

The address management directory 21 manages information that data was obtained from the transfer destination bus control device 4 and held in the information holding circuit 9 according to the control information format of FIG. 5. Subsequently, when the transfer source bus control device 1 obtains data from the transfer destination bus control device 4, the address management directory 21 detects that data which the transfer source bus control device 1 requests exists in the information holding circuit 9. Since the access destination of the transfer source bus control device 1 is changed from the transfer destination bus control device 4 to the information holding circuit 9, the address management directory 21 changes the first information processing target to the information holding circuit 9 according to the control information format of FIG. 2. Thus, the bus selection circuit 12 and the bus selection circuit 14 select connection to the ring bus 10, and the transfer source bus control device 1 obtains data from the information holding circuit 9 of the transfer source bus control device 3 which is the first information processing target.

### Fourth Embodiment

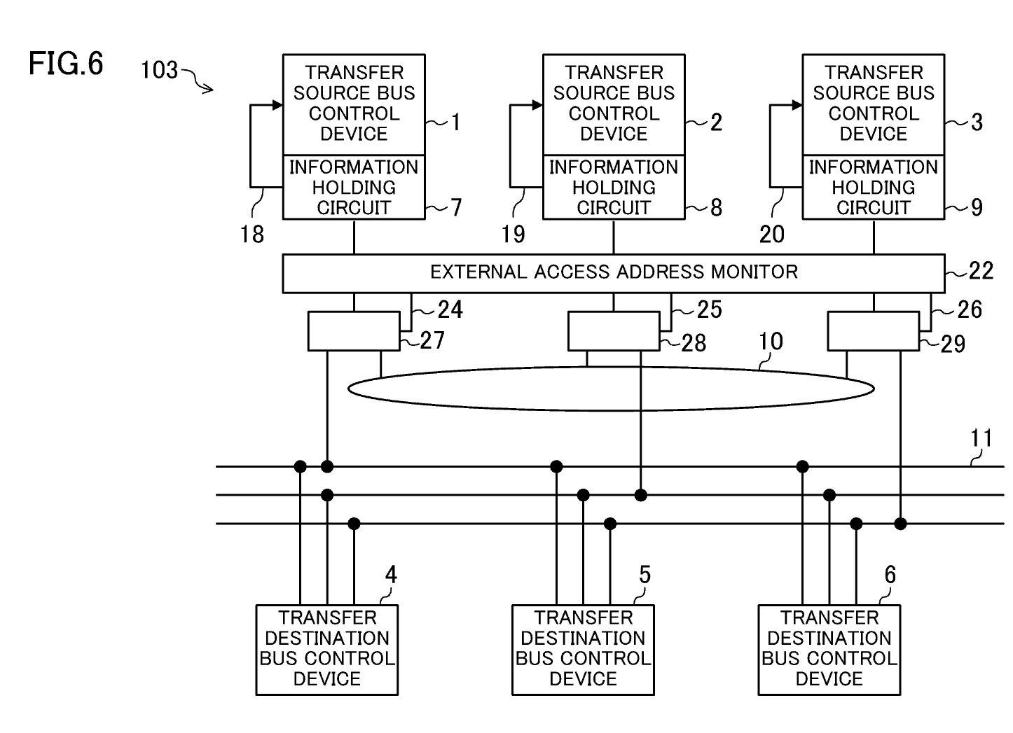

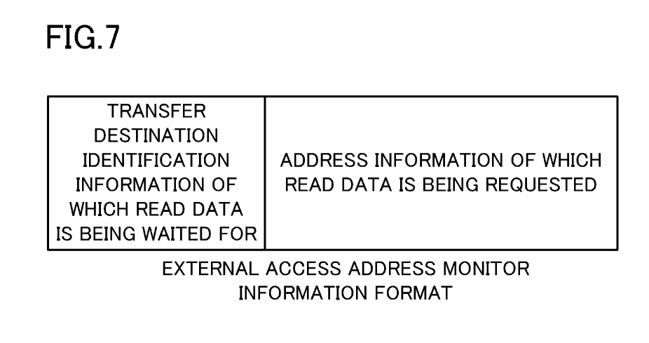

FIG. 6 is a block diagram schematically illustrating a configuration of an information processing apparatus 103 according to a fourth embodiment. The information processing apparatus 103 employs control information formats of FIG. 2 and FIG. 7. Only differences of the fourth embodiment from the second embodiment will be described below.

The information processing apparatus 103 includes an external access address monitor 22 configured to monitor access destination information of the transfer source bus control devices 1-3. Bus selection circuits 27-29 select one of the ring bus 10 and the hierarchical bus 11 according to output signals of the transfer source bus control devices 1-3 and an output signal of the external access address monitor 22.

The operation of the information processing apparatus 103 configured as described above will be described below. First, assume a case where the transfer source bus control device 3 obtains data from the transfer destination bus control device 4, and furthermore, the transfer source bus control device 1 and the transfer source bus control device 2 simultaneously obtain data from the transfer destination bus control device 4.

When the transfer source bus control device 3 obtains data from the transfer destination bus control device 4, the external access address monitor 22 resisters information that the transfer source bus control device 3 is obtaining data from the transfer destination bus control device 4 according to the control information format of FIG. 7. Subsequently, when the transfer source bus control device 1 and the transfer source bus control device 2 obtain data from the transfer destination bus control device 4, the external access address monitor 22 detects that the transfer source bus control device 3 is obtaining data, and puts an access of each of the transfer source bus control device 1 and the transfer source bus control device 2 to the transfer destination bus control device 4 in a wait state.

The external access address monitor 22 outputs selection circuit control signals 24-26. Thus, the bus selection circuit 27 selects connection to the ring bus 10, the bus selection circuit 28 selects connection to the ring bus 10, and the bus selection circuit 29 selects connection to the hierarchical bus 11. The transfer source bus control device 3 obtains data from the transfer destination bus control device 4, and completes information processing. The bus selection circuit 29 selects connection to the ring bus 10 according to an output signal of the transfer source bus control device 3. The transfer source bus control device 1 and the transfer source bus control device 2 obtain data from the information holding circuit 9 of the transfer source bus control device 3 via the ring bus 10.

Note that the transfer source bus control device 1 and the transfer source bus control device 2 may be configured to receive data directly from the ring bus 10. For example, assume that information that the transfer source bus control device 3 is obtaining data from the transfer destination bus control device 4 and information that an access of each of the transfer source bus control device 1 and the transfer source bus control device 2 to the transfer destination bus control device 4 is in a wait state are registered in the external access address monitor 22. In this case, when the bus selection circuit 27 receives the selection circuit control signal 24, the bus selection circuit 27 provides connection to an input port configured to receive data from the ring bus 10, and also provides connection to an input/output port configured to transmit/receive data to/from the external access address monitor 22. Similarly, the bus selection circuit 28 provides connection to an input port configured to receive data from the ring bus 10 and connection to an input/output port configured to transmit/receive data to/from the external access address monitor 22.

When the bus selection circuit 29 receives the selection circuit control signal 26, the bus selection circuit 29 provides connection to an input port configured to receive data from the hierarchical bus 11 and an output port configured to output data to the ring bus 10 according to the control information registered in the external access address monitor 22, and provides connection to an input/output port for transmitting/receiving control information to/from the external access address monitor 22.

When each port of the bus selection circuits 27-29 is connected, the transfer source bus control device 3 obtains data from the transfer destination bus control device 4 via the hierarchical bus 11 and the bus selection circuit 29. In conjunction with this, the bus selection circuit 29 transfers data to the ring bus 10. The transfer source bus control device 1 and the transfer source bus control device 2 obtain data from the ring bus 10 via the bus selection circuit 27 and the bus selection circuit 28, respectively.

### Fifth Embodiment

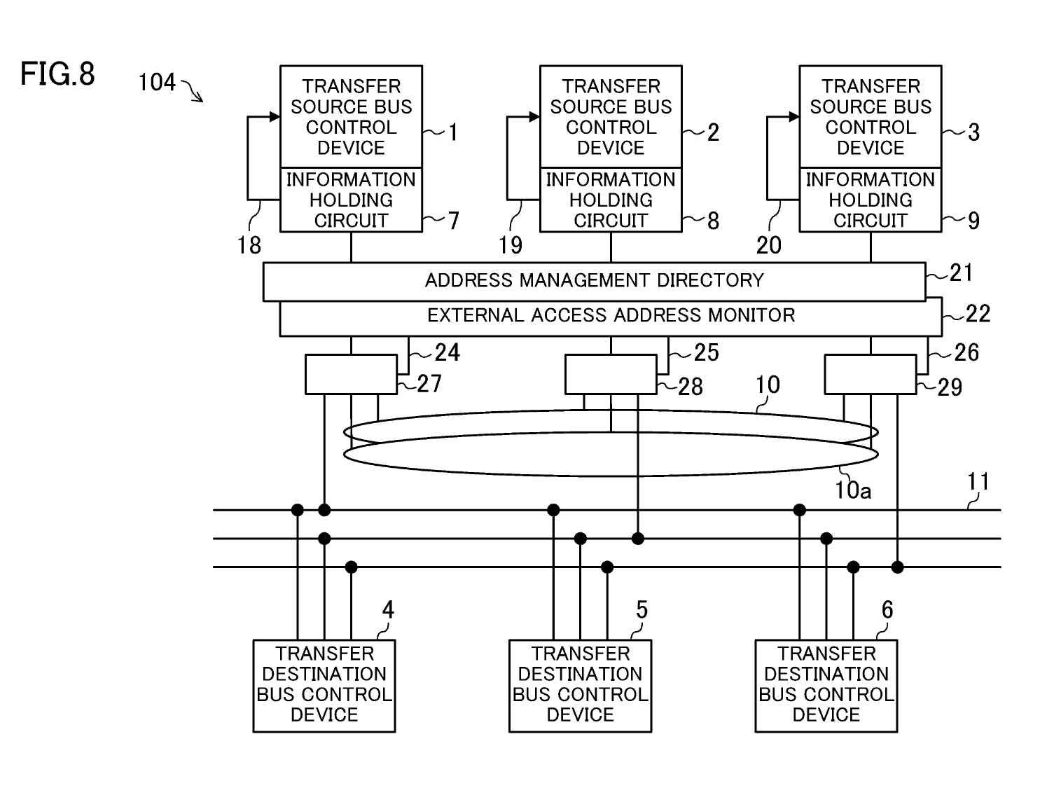

FIG. 8 is a block diagram schematically illustrating a configuration of an information processing apparatus 104 according to a fifth embodiment. The information processing apparatus 104 employs control information formats of FIG. 2, FIG. 5, and FIG. 7.

In the information processing apparatus 104, the second embodiment, the third embodiment, and the fourth embodiment are used in combination. For example, when the transfer source bus control devices 1-3 perform data transfer based on control information managed by the address management directory 21, the ring bus 10 is used. On the other hand, when data transfer is performed based on control information registered in the external access address monitor 22, a ring bus 10A is used. Using different information processing in combination, information processing can be performed without reducing the advantages of each of the embodiments, thus resulting in improvement of the transfer efficiency of the on-chip bus and the SoC performance, and reduction in power consumption of the on-chip bus. Note that a configuration where only one ring bus is provided may be employed.

### Sixth Embodiment

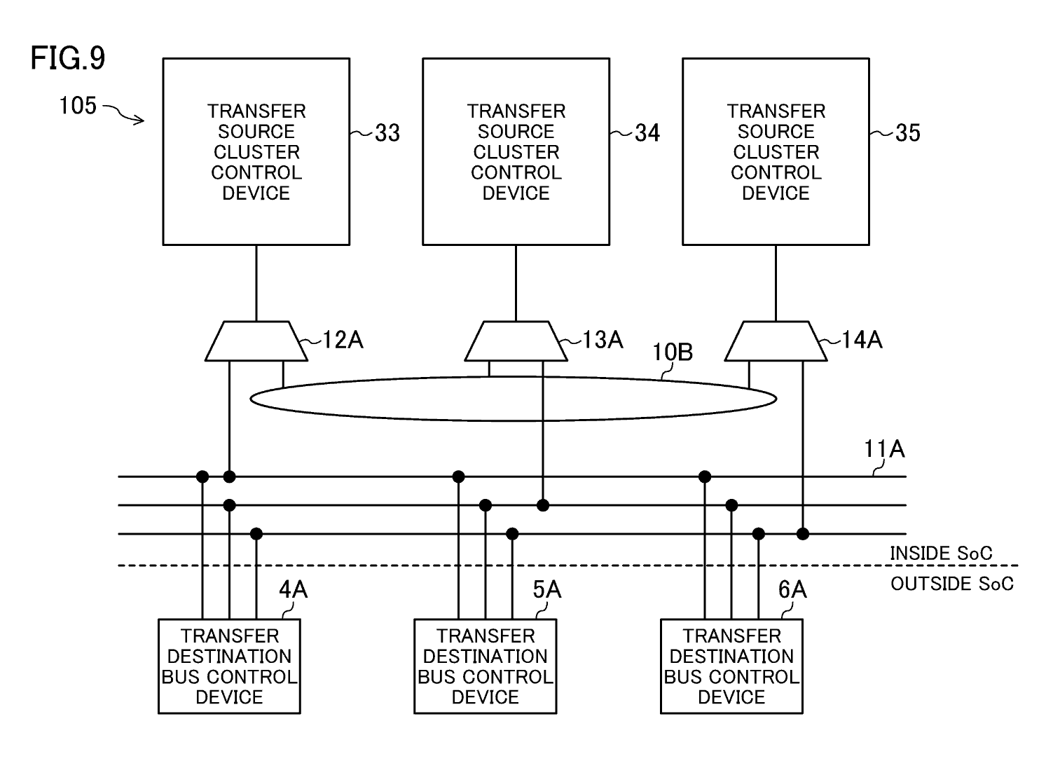

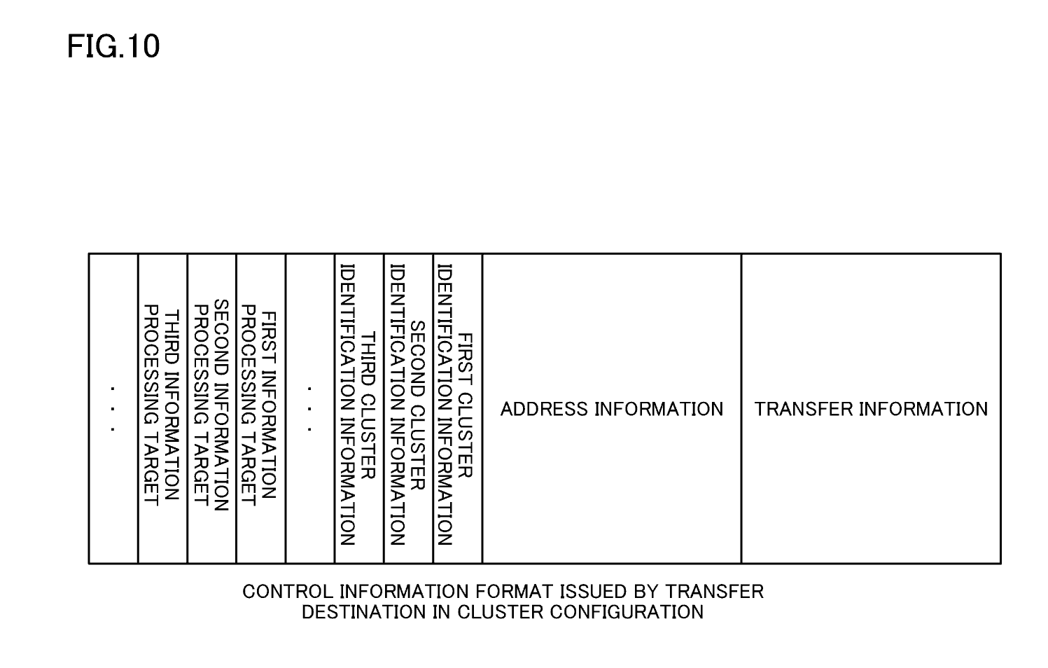

FIG. 9 is a block diagram schematically illustrating a configuration of an information processing system 105 according to a sixth embodiment. The information processing system 105 employs a control information format of FIG. 10.

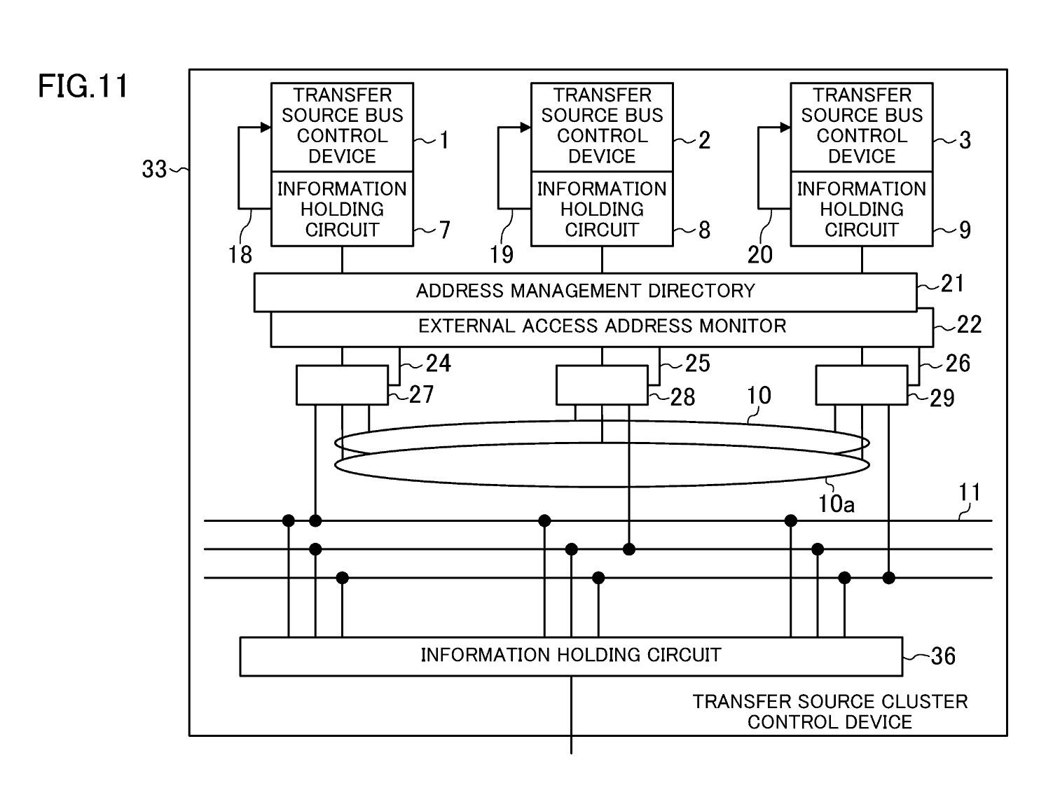

In the information processing system 105, the information processing apparatus 104 of FIG. 8 is used as a transfer source cluster control apparatus 33 of FIG. 11. The information processing system 105 is configured so that data is transmitted/received between a plurality of transfer source cluster control apparatuses 33-35 and a plurality of transfer destination bus control devices 4A-6A via a hierarchical bus 11A. The information processing system 105 includes cluster information holding circuits 36 provided respectively for the transfer source cluster control apparatuses 33-35, a ring bus 10A configured to be capable of mutually connecting the plurality of cluster information holding circuits 36, and bus selection circuits 12A-14A configured to select one of a ring bus 10B and the hierarchical bus 11A according to output signals of the transfer source cluster control apparatuses 33-35.

In the information processing system 105 configured as described above, using the control information format of FIG. 10 obtained by adding cluster identification information to the control information format of FIG. 2, the same operation as that of the first embodiment can be expanded so that the operation is performed cluster by cluster.

As described above, by adding cluster identification information to the control information format, information processing can be performed not only in the SoC but also extendedly outside the SoC, thus resulting in improvement of the transfer efficiency between chips and the system performance, and reduction in power consumption of a board.

Note that in the first through sixth embodiments, mesh buses may be used, instead of the ring buses 10, 10A, and 10B.

What is claimed is:

1. An information processing apparatus which is configured so that a plurality of transfer source bus control devices and a plurality of transfer destination bus control devices transmit/receive data therebetween via a hierarchical bus, the apparatus comprising:
information holding circuits provided respectively for the plurality of transfer source bus control devices;
an exclusive bus configured to be capable of mutually connecting the plurality of information holding circuits; and
bus selection circuits provided respectively for the plurality of transfer source bus control devices and configured to select one of the exclusive bus and the hierarchical bus as a connection destination of each of the transfer source bus control devices.

2. The information processing apparatus of claim 1, further comprising:
notification buses each of which is configured to notify an associated one of the transfer source bus control devices that data exists in an associated one of the information holding circuits.

3. The information processing apparatus of claim 1, further comprising:
an address management directory configured to change an access destination of each of the transfer source bus control devices from one of the transfer destination control devices to one of the information holding circuits which holds data requested by an associated one of the transfer source bus devices.

4. The information processing apparatus of claim 1, further comprising:
an external access address monitor configured to put, when two or more of the transfer source bus control devices request for the same data, a request or requests of one or more of the two or more transfer source bus control devices other than one of the two or more transfer source bus control devices which makes a request first in a wait state,
wherein
the bus selection circuits are controlled according to an output signal of the external access address monitor.

5. The information processing apparatus of claim 1, wherein
the exclusive bus is a ring bus.

6. The information processing apparatus of claim 1, wherein
the exclusive bus is a mesh bus.

7. The information processing apparatus of claim 1, wherein
the plurality of transfer source bus control devices include first and second transfer source bus control devices,
the first transfer source bus control device performs information processing to data, and sets, as control information, address information indicating a transfer destination of the data to which the information processing has been performed, and
when the control information contains address information of the second transfer source bus control device, one of the bus selection circuits which corresponds to the first transfer source bus control device selects the exclusive bus, and the first transfer source control device transfers the data to which the information processing has been performed to one of the information holding circuits which corresponds to the second transfer source bus control device.

8. An information processing system which is configured so that multiple ones of the information processing apparatus of claim 1 as a plurality of transfer source cluster control devices and a plurality of transfer destination bus control devices transmit/receive data therebetween via a second hierarchical bus, the system comprising:
cluster information holding circuits provided respectively for the transfer source cluster control devices;
a second exclusive bus configured to be capable of mutually connecting the plurality of cluster information holding circuits; and
bus selection circuits provided respectively for the transfer source cluster control devices and configured to select one of the second hierarchical bus and the second exclusive bus as a connection destination of each of the transfer source cluster control devices.

9. The information processing system of claim 8, wherein
the second exclusive bus is a ring bus.

10. The information processing system of claim 8, wherein
the second exclusive bus is a mesh bus.
